(19) United States
(12) Patent Application Publication
(10) Pub. No.: US 2011/0022752 A1
(43) Pub. Date: Jan. 27, 2011

(54) METHOD FOR TRANSMITTING DATA IN A CYCLE-BASED COMMUNICATION SYSTEM

(76) Inventors: Marc Schreier, Ditzingen (DE); Corina Weber, Vaihingen/Enz (DE)

Correspondence Address: KENYON & KENYON LLP, ONE BROADWAY, NEW YORK, NY, 10004, US

(21) Appl. No.: 12/735,136

(22) PCT Filed: Dec. 10, 2008
(86) PCT No.: PCT/EP2008/067226

§ 371 Date: Oct. 13, 2010

(30) Foreign Application Priority Data
Dec. 20, 2007 (DE) 10 2007 061 724.2

(51) Int. Cl. G06F 13/42; G06F 13/00

(52) U.S. Cl. 710/105; 710/100

(57) ABSTRACT

In a method for transmitting data from a transmitting user of a cycle-based communication system to a receiving user of the communication system, the data are transmitted via a communication medium in messages that repeat in communication cycles and that respectively include a plurality of data blocks. The receiving user identifies the end of the data blocks in the received messages and subsequently extracts the transmitted data from the identified data blocks.

### BACKGROUND OF THE INVENTION

1. Field of the Invention

The present invention relates to a method for transmitting data from a transmitting user of a communication system to a receiving user of the communication system via a communication medium of the communication system. The data are transmitted via the communication medium in messages, which respectively include a plurality of data blocks. The receiving user identifies the end of the data blocks in the received messages and subsequently extracts the transmitted data from the identified data blocks.

2. Description of Related Art

In recent years, there has been a dramatic increase in the networking of control units, sensor systems, and actuator technology via a communication system and a communication link, for example in the form of a bus system, in the manufacturing of modern motor vehicles or also in machine manufacturing, especially in the machine tool sector, as well as in automation processes. In this context, synergistic effects may be attained when functions are distributed among a plurality of control units. In this case, one speaks of distributed systems.

The communication between various users of such a data transmission system is increasingly being implemented via a bus system. The communication traffic on the bus system, access and receiving mechanisms, and error handling are governed by a protocol. For instance, the FlexRay protocol, which is currently based on the FlexRay protocol specification v2.1, is one known protocol. FlexRay is a rapid, deterministic, and fault-tolerant bus system which is especially conceived for use in motor vehicles. The FlexRay protocol operates according to the principle of time division multiple access (TDMA), in which the users or the messages to be transmitted are assigned fixed time slots during which they have exclusive access to the communication link. The time slots repeat in a fixed cycle, so that the instant at which a message is transmitted via the bus can be predicted exactly, and the bus access takes place deterministically.

To allow for the bandwidth for transmitting messages on the bus system to be optimally utilized, FlexRay subdivides the messages into a static and a dynamic segment. The fixed time slots are located in the static segment at the beginning of a message. In the dynamic segment, the time slots are defined dynamically. In this segment, each exclusive bus access is permitted for only a brief time period, at least for the duration of what is commonly referred to as a minislot. The time slot is extended by the requisite time period only if a bus access takes place within a minislot. Thus, bandwidth is only used when it is actually needed. In this context, FlexRay communicates via one or two physically separate lines at a maximum data rate of 10 Mbit/sec in each case. Of course, it is also possible to operate FlexRay at lower data rates. The two channels correspond to the physical layer, in particular of what is generally referred to as the OSI (open system architecture) layer model. They are used primarily for the redundant and thus fault-tolerant transmission of messages, but are also capable of transmitting different types of messages, which doubles the data rate. It is also conceivable that the signal transmitted over the connection lines is derived from the difference between the signals transmitted via the two lines. The physical layer is configured in such a way that it permits an electrical, but also an optical transmission of the signal or signals via the line(s) or a transmission in another way (for example, radio, infrared, etc.)

The users in the communication network require a common time base, the so-called global time, in order to implement synchronous functions and to optimize the bandwidth through small intervals between two messages. For the clock synchronization, synchronization messages are transmitted in the static portion of the cycle, the local clock time of a user being corrected with the aid of a special algorithm according to the FlexRay specification in such a way that all local clocks run in synchronism with a global clock.

Messages in a FlexRay communication system are also called FlexRay frames. The messages include a plurality of data blocks (so-called protocol data units, PDUs) having the data to be transmitted. The length of the data blocks is normally predefined in a fixed manner according to the FlexRay specification. The length of the data blocks is predefined in a fixed manner as part of the configuration of the communication system. Therefore, messages having a plurality of data blocks having variable lengths are unable to be implemented in FlexRay at this time. However, for specific types of data transmission in a FlexRay communication system, it would be desirable to be able to transmit data in messages having a plurality of data blocks having variable lengths. For example, this would be desirable for the transmission of new software via the communication medium to reprogram a control device (user) or for the transmission of diagnosis information from one or a plurality of control devices (users) to a tester unit connected to the communication system. A data transmission in messages having a plurality of data blocks having variable lengths would also be desirable for transmitting multimedia data or for transmitting data of other so-called infotainment functions. In principle, a data transmission in messages having a plurality of data blocks of variable lengths would be of interest whenever relatively high bandwidths are necessary and a data transmission in realtime is not critical.

However, theoretically data blocks having variable lengths are also conceivable according to FlexRay specification. However, in such a case, a message includes only one single data block. This is based on the fact that the length of the message is stored in a header of the message, among other things as well, and is transmitted along with the data blocks; however, the length of the data blocks is not included in the message and consequently is not transmitted. The simplification that each message includes only one data block makes it possible to infer from the transmitted length of the message the length of the single data block contained therein. However, the desired high data rates cannot be achieved by messages having only one data block having a variable length.

According to the related art, in a transmitting FlexRay user or in a communication controller of the user, the data to be transmitted are distributed among the data blocks of the messages and transmitted via the communication medium. The transmitting user obtains knowledge about the fixed length of the data blocks through the configuration of the FlexRay communication system, so that it may accordingly distribute the data to be transmitted among the data blocks. Likewise, the receiving user obtains knowledge about the length of the data blocks through the configuration of the FlexRay communication system, so that it may accordingly extract the transmitted data from the data blocks. If data blocks having variable lengths are used, information conveyed in the header of the message regarding the length of the message is used in the receiving user to infer the length of the data block contained therein, and the transmitted data may be extracted from the data block. Thus, in the related art the data blocks of the messages are identified either via the configuration data or via the transmitted length of the messages.

### BRIEF SUMMARY OF THE INVENTION

Starting from the described related art, an objective of the present invention is to allow for a data transmission in messages including a plurality of data blocks having variable lengths in a manner as simple, cost-effective, and robust as possible, in a FlexRay communication system.

The present invention relates to a receiving user of a cycle-based communication system. The communication system includes the user, at least one additional user, and at least one communication medium, which connects the users to each other for data transmission purposes. The user and the at least one additional user have means for transmitting data via the communication medium in messages that respectively include a plurality of data blocks. The user has first means for identifying the end of the data blocks in the received messages and second means for subsequently extracting the transmitted data from the identified data blocks.

Finally, the present invention also relates to a transmitting user of a communication system. The communication system includes the user, at least one additional user, and at least one communication medium, which connects the users to each other for data transmission purposes. The user and the at least one additional user have means for transmitting data via the communication medium in messages that respectively include a plurality of data blocks. The user has means for inserting the data to be transmitted into the data blocks for the subsequent transmission of the data in repeating messages via the communication medium.

The receiving user identifies the end of each data block in the received messages, at least for the data blocks having variable lengths, in that it reads in and evaluates information from the data block regarding the length of the data block, which is conveyed at least in the data blocks having variable lengths, or in that it reads in and evaluates information regarding the end of the data block, which is transmitted at least after the data blocks having variable lengths.

The idea providing the basis of the present invention essentially involves making it possible for the receiving users of the communication system to identify the length of the data blocks in the received messages. To this end, according to the present invention two different options are proposed, both of which allow for a data transmission in messages including a plurality of data blocks having variable lengths in a manner as simple, cost-effective and robust as possible.

In accordance with the first option, in the transmitting user of the communication system, information regarding the length of the data block is inserted in the message, at least for the data blocks having variable lengths. Of course, by default this information may be transmitted both for the data blocks having variable lengths and for the data blocks having fixed lengths. In each instance, the information may be inserted in front of a data block, in which case it contains the length of the subsequent data block, or the length information is inserted directly into the data block and is thus a part of the data block. The information may be inserted, for example, in a header of the data block and may be transmitted along with the data block in the message to the receiver or the receivers. In this manner, the receiving user receives information about the length of the received data blocks and may also ascertain the end of the respective data blocks without great effort, even when the length of the data blocks is variable. This is necessary in order for the receiving user to extract the correct data from the incoming message (that is, the incoming bit stream). To wit, it is frequently the case that the data blocks of an incoming message are intended for different receivers. If, for example, the third data block of a message is intended for a specific receiver, this receiver must know exactly where and when the preceding second data block stops, that is, where the third data block begins and where or when the third data block stops. Only in this way is it possible for the receiver to extract from the message precisely the data from the third data block that is intended for it.

According to a second option of the present invention, in the transmitting user of the communication system, information regarding the end of the data blocks is inserted in the messages after the data blocks, at least for the data blocks having variable lengths. Of course, by default this information may be transmitted both for the data blocks having variable lengths and for the data blocks having fixed lengths. The information may be a type of marking that signals the end of every single data block and is inserted in the message directly after the data block. The receiving user detects it while receiving and evaluating the incoming message (that is, the incoming bit stream). For example, the information may be a specific bit combination. The receiving user reads in the incoming data stream, evaluates it, and detects the information contained therein regarding the end of the data block—in as much as this information exists. The receiver knows from the configuration where or when the first data block of a message begins. The information regarding the end of the data blocks that is transmitted in the message tells the receiver where or when the first data block and all additional data blocks having variable lengths stop. In the case of the data blocks having a constant length, the receiver either knows the end of the data blocks from the configuration, or the receiver ascertains the end of the data blocks with the aid of the transmitted information regarding the end of the data blocks.

Preferably, the method according to the present invention is used in a cycle-based communication system, the data being transmitted via the communication medium in messages that repeat themselves in communication cycles. Examples of cycle-based communication systems include the interbus field bus system, the so-called “lighting control bus” (according to the DMX-512 protocol), TTCAN (Time Triggered CAN), and FlexRay.

Preferably, the bit combination is uniquely identifiable, that is, it differs from bit combinations that are transmitted in practice or are theoretically transmittable. It is particularly advantageous if the information is made up of one or two bytes, the content of which differs from the bytes that are transmitted in practice and thus allows for a unique identification of the end of a data block. Thus, according to an advantageous further refinement of the present invention, the content of the bytes of the data to be transmitted in the messages is ascertained in the transmitting user, and a bit combination that does not occur as content of the bytes of the data to be transmitted in the messages is selected as information regarding the end of the data block.

A further example embodiment of the present invention provides for data in the communication system to be transmitted in accordance with a FlexRay protocol. The present invention has significant advantages for a FlexRay communication system in particular, since now for the first time it is possible to transmit data in messages containing a plurality of data blocks having variable lengths, in a manner as simple, cost-effective, and robust as possible. The data blocks having variable lengths are a part of the static and/or of the dynamic segment of the FlexRay messages. Data is transmitted in messages comprising a plurality of data blocks having variable lengths in particular wherever high data transmission rates have to be achieved and wherever a data transmission in real time is not necessarily required.

The information regarding the end of the data block advantageously contains at most two bytes. If one assumes that the maximum length of a FlexRay message is 254 bytes, then it is possible to implement 2¹⁶=65,536 possible bit combinations (or different markings) using a two-byte long (equals 16 bit) piece of information. This results in a high probability that a two-byte long bit combination will be selected for the marking of the end of the data block, which combination does not occur in the transmitted data (or in the transmitted bit stream). The selected marking may always be the same for all messages transmitted in the communication system. For example, one may select a bit combination that occurs only seldom. That is to say, the marking should be as independent as possible from the transmitted data. In this specific embodiment, it is thus possible to refrain from ascertaining in the transmitting user the content of the bytes of the data to be transmitted in the messages, and to refrain from selecting as information regarding the end of the data block a bit combination that does not occur as content of the bytes of the data to be transmitted in the messages. Thus, the same bit combination may always be used as a marking. This may be communicated to the users of the communication system as part of the configuration, for example, so that the receiving users know which bit combination to search for in the received data (or the received bit stream).

However, if the content of the bytes of the data to be transmitted in the messages is ascertained in the transmitting user and if a bit combination that does not occur as content of the bytes of the data to be transmitted in the messages is selected as information regarding the end of the data block, the marking of the end of the data blocks may comprise exactly one byte. If one assumes that the maximum length of a FlexRay message is 254 bytes, it is possible to implement 2⁸=256 possible bit combinations (or different markings) using a one-byte long (equals 8 bits) piece of information. Thus, it is always possible to find a bit combination for the marking, which does not occur in the transmitted data (or in the transmitted bit stream). However, in this specific embodiment, the marking used may vary from message to message. Thus, information regarding the marking used is also usefully transmitted in the message, so that the receiving users know which bit combination they need to search for in the received data (or in the received bit stream).

According to another advantageous refinement of the present invention, information regarding the minimum length of the data blocks and/or the maximum length of the data blocks is available to the receiving user, and the receiving user does not search the entire message for the information regarding the end of the data blocks, but rather only the region of windows delimited by the minimum and the maximum length of the data blocks. The information regarding the minimum and maximum length of the data blocks may be communicated to the users of the communication system through the configuration. On the basis of this information, the receiver determines a window within which it searches the incoming data stream for the markings of the end of the data blocks. The receiver knows where or when the first data block begins. Starting from the beginning of the first data block, the receiver places the window, within which it searches for the marking of the end of the first data block, on the corresponding region of the incoming bit stream. Starting from the ascertained end of the first data block (corresponding to the beginning of the second data block), the receiver places the window, within which it searches for the marking of the end of the second data block, on the corresponding region of the incoming bit stream, and so on. This refinement is particularly interesting when the content of the bytes of the data to be transmitted in the messages is not ascertained in the transmitting user and when there is no selection of a bit combination that does not occur as content of the bytes of the data to be transmitted in the messages as information regarding the end of the data block. The regions of the bit stream in which the markings of the end of the data blocks cannot occur anyway are situated outside of the windows and therefore outside of the analyzed data. Even if these regions were to contain a bit combination that corresponds to the bit combination of the marking, it would not trigger a faulty detection of the end of a data block, since this data region would not be searched and therefore the wrong marking would not be detected.

The present invention requires a modification or supplement both in the transmitting user and in the receiving user. In particular, in the users the so-called COM layer or the driver software, in particular the FlexRay driver software, must be modified such that in the transmitter the information regarding the length of the data blocks or the information regarding the end of the data blocks may be stored in the data blocks or in the messages, and in the receiver the stored information may be extracted from the messages. If the detection of the marking were performed in the FlexRay driver, this would be transparent for the COM layer, which then would not have to be modified. The configuration of the communication system is adjusted to the data transmission according to the present invention, so that the users have access to the additional information that is required in order to implement the present invention (i.e., minimum, maximum length of the data blocks; bit combination used for the marking).

### BRIEF DESCRIPTION OF SEVERAL VIEWS OF THE DRAWING

FIG. 1 shows an example embodiment of a communication system for implementing the present invention.

FIG. 2 shows a first example embodiment of a message for transmitting data in a communication system according to FIG. 1.

FIG. 3 shows a second example embodiment of a message for transmitting data in a communication system according to FIG. 1.

FIG. 4 shows a third example embodiment of a message for transmitting data in a communication system according to FIG. 1.

FIG. 5 shows a fourth example embodiment of a message for transmitting data in a communication system according to FIG. 1.

FIG. 6 shows a fifth example embodiment of a message for transmitting data in a communication system according to FIG. 1.

FIG. 7 shows a sixth example embodiment of a message for transmitting data in a communication system according to FIG. 1.

FIG. 8 shows a comparison of a transmitted and received message according to a seventh example embodiment of the present invention.

FIG. 9 shows a comparison of a transmitted and received message according to an eighth example embodiment of the present invention.

FIG. 10 shows a comparison of a transmitted and received message according to a ninth example embodiment of the present invention.

FIG. 11 shows a message for data transmission in a communication system, known from the related art.

### DETAILED DESCRIPTION OF THE INVENTION

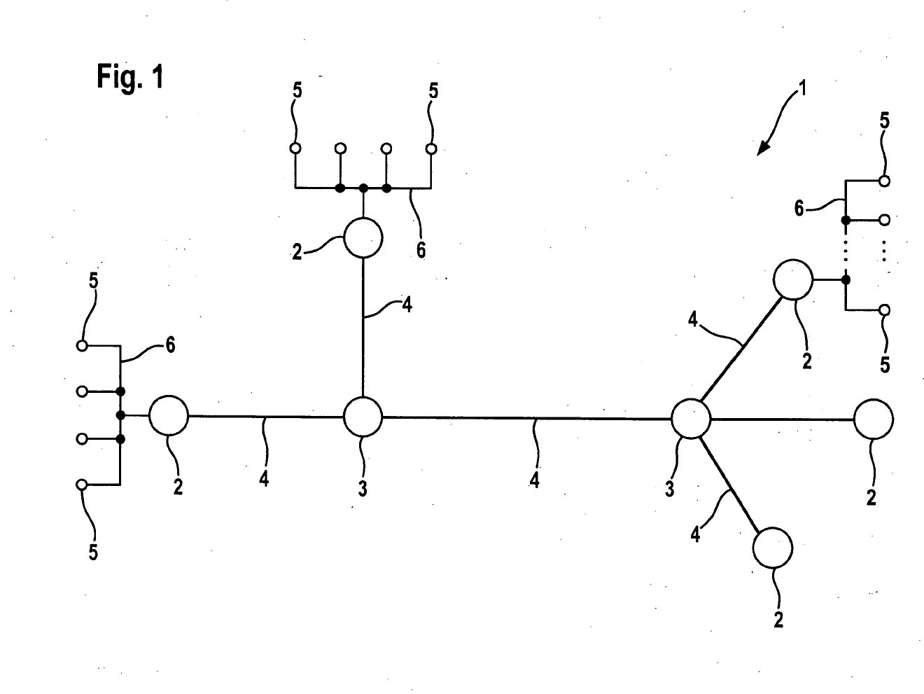

A communication system for implementing the method according to the present invention is labeled in its entirety by reference numeral 1 in FIG. 1. It includes a plurality of users 2, five in the exemplary embodiment shown, and optionally one or more, two in the exemplary embodiment shown, active star couplers 3. For example, users 2 comprise an engine control unit, a control device for an interior ventilation or another comfort function and/or an automatic transmission control device. Users 2 and star couplers 3 are connected to each other via a communication medium 4 (thick line) such that a kind of star topology results for system 1. Active star couplers 3 have primarily a router and/or amplifier function. Communication medium 4 is preferably designed as a data bus.

Communication system 1 is used for the transmission of data between users 2. The communication traffic on bus system 4, access and receiving mechanisms on the part of users 2, and error handling are governed by a protocol. For instance, the FlexRay protocol, which is currently based on the FlexRay protocol specification v2.1, is one known protocol. FlexRay is a rapid, deterministic, and fault-tolerant communication system which is intended especially for use in motor vehicles. The FlexRay protocol operates according to the principle of time division multiple access (TDMA), in which users 2 or the messages to be transmitted are assigned fixed time slots during which they have exclusive access to communication medium 4. The time slots repeat in a fixed cycle, so that the instant at which a message is transmitted via bus 4 can be predicted exactly, and the bus access takes place deterministically. The present invention is explained in the following by way of example for a FlexRay communication system. Of course, the present invention may also be used in other communication systems, in which the data may be transmitted according to a protocol other than the FlexRay protocol, in messages that repeat in communication cycles and that respectively include a plurality of data blocks of variable lengths.

Electric units 5, for example, in the form of wheel speed sensors, tire air-pressure sensors, injection pressure sensors, engine temperature sensors, steering angle sensors, electric motors for comfort functions (seat adjuster, recirculation flap of the ventilation, electric window raiser, etc.), fans for comfort functions (interior ventilation, seat ventilation, seat adjuster), monitor, navigation system, multimedia system, and so on, are connected to users 2. Electric units 5 are also preferably connected to users 2 via a bus system 6, in particular via a CAN (controller area network) bus, a MOST (media oriented systems transport) bus, or a LIN (local interconnect network) bus. The data to be transmitted via communication system 1 come from electric units 5 or are generated in transmitting users 2 (possibly as a function of variables that electric units 5 have transmitted to transmitting users 2). The data transmitted via communication system 1 are further processed in receiving users 2 and/or transmitted via connection 6 to electric units 5 for further processing.

In FIG. 11, an example of a FlexRay message known from the related art is labeled in its entirety with reference numeral 10. Message 10 is also known as a FlexRay frame. It includes a header 11 at the beginning of message 10 and a trailer 12 at the end of message 10. Payload 13 is accommodated in between. Payload 13 includes a plurality of data blocks (so-called protocol data units; PDUs), three in the exemplary embodiment shown. Different data for different receivers are accommodated in PDUs 14. Thus, for example, the engine speed is stored in PDU #1, and the data stored in PDU #1 are transmitted from a specific user 2 (e.g., engine control device) to another user 2 (e.g., automatic transmission control device). For example, the engine temperature is stored in PDU #2, and the data stored in PDU #2 are transmitted from a specific user 2 (e.g., engine control device) to another user 2 (e.g., control device for the interior ventilation). According to the related art, PDUs 14 of message 10 have a constant length (static configuration having constant data length). In the related art, it is possible to transmit data in messages having a data block 14 of variable length only if a message 10 includes only one single data block 14, since in such a case it is possible to infer the length of the single data block contained in the message from the length information of the message transmitted along with the message.

In particular in the case of a data transmission via the communication system that requires a high transmission rate, but for which a real-time transmission is only of secondary importance, e.g., when a control device is reprogrammed (data transmission from an external programming device to a user 2 of communication system 1), or when diagnosis information is read out (data transmission from a user 2 of communication system 1 to an external tester), it would be desirable to create another option for data to be transmitted in messages that include a plurality of data blocks, of which at least two have a variable length. Such an option is created with the aid of the present invention.

In order to extract PDUs 14 from a message 10, it must be possible to detect the end of a PDU or the beginning of the subsequent PDU, in particular in PDUs having variable length. An essential part of the subsequent description of the drawing is therefore aimed at recognizing a dynamic PDU within a message.

A first way of recognizing the end of a PDU or the beginning of the subsequent PDU is to insert information regarding the length of the data block in the data block, at least in the data blocks having variable lengths, and to transmit it along with the data block. In receiving user 2, the data block or the data contained therein is/are read in and the length of the data block is extracted. The beginning of the first data block and the length of the data blocks having constant length are known to users 2 via the configuration. Only the length and thus the end of the data blocks having variable lengths cannot be provided to users 2 via the configuration. Receiving users 2 now receive this missing information via the received data blocks themselves, since at least in the data blocks having variable lengths, the information regarding the length of the data blocks is also transmitted and may be evaluated by the receiver.

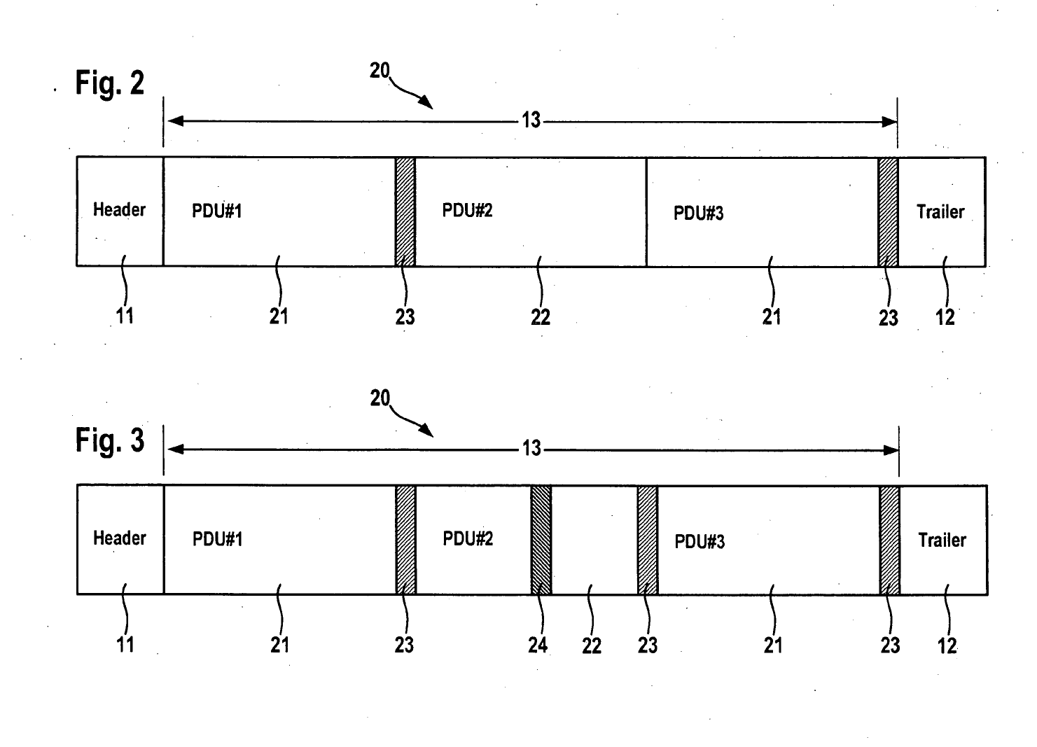

Another way of recognizing the end of a PDU or the beginning of the subsequent PDU is subsequently explained in more detail with the aid of FIG. 2. In it, a message is labeled in its entirety by reference numeral 20. The illustrated message 20 includes a header 11 and a trailer 12, as well as three PDUs 21, 22, of which two PDUs 21 have a dynamic length and one PDU 22 has a constant length. In each instance, a so-called end-of-PDU (EOP) marker 23 is inserted after PDUs 21, which includes information regarding the end of a data block 21 and which is inserted into message 20 after a data block 21 having variable length in transmitting user 2. Preferably, marker 23 is not added manually by the application software of transmitting user 2 to PDU 21 to be transmitted, but rather by the communication driver of transmitting user 2. The driver adds EOP marker 23 to transmitting PDUs 21 where necessary, so that it is transparent for the user layer.

EOP marker 23 makes it possible for receiving user 2 to ascertain the end of a data block 21 or the beginning of subsequent data block 22 and to read in the data transmitted in data blocks 21, 22, even in messages that have a plurality of data blocks 21 having variable lengths (PDUs 21 having dynamic lengths). In this manner, the available bandwidth of communication medium 4 may be utilized in an optimum manner.

Two additional bytes that feature a specific bit pattern are preferably added to the end of a PDU 21 as EOP marker 23. To ensure that marker 23 may be reliably detected, the use of two bytes is recommended, since this means that there is a higher probability that the bit pattern of EOP marker 23 is not contained in the transmitted data of payload 13, and that EOP marker 23 thus contains a characteristic pattern. A FlexRay message includes a maximum of 254 bytes, that is a maximum of 254 different bit patterns. When two bytes are used for marker 23, 2¹⁶=65,536 possible bit pattern combinations result. The probability that the bit pattern selected for EOP marker 23 is also contained in the transmitted data of payload 13 is therefore 1 to 256 and thus is very low. Additionally, measures to reduce the probability of a faulty detection of a bit pattern of payload 13 even farther or to even rule it out completely are conceivable.

Alternatively, it is also possible to calculate the content of EOP marker 23 dynamically at the runtime of the data transmission. To this end, the content of the data of payload 13 to be transmitted or the bit pattern of the bytes of message 20 is analyzed before the data transmission. Then, for EOP marker 23 a bit combination is selected that is not contained in the maximum of 254 bytes of payload 13 that is transmitted. In this alternative embodiment, even one byte is sufficient for EOP marker 23, since this results in a total of 2⁸=256 possible bit pattern combinations for marker 23, that is, more than the maximum possible 254 different bit combinations of the bytes of message 20.

A plurality of PDUs 21, 22 may be transmitted in a FlexRay message. These PDUs may be assigned to different applications, e.g., network management (NM), transport layer (TP), or others, or may be used to transmit signals and messages of the application software. Since PDUs 21, 22 are used for different application cases, their size may vary. For this reason, a plurality of combinations of PDUs 21, 22 having dynamic or static content in a message 20 may be considered:
a) a PDU 22 having a constant length,
b) a plurality of PDUs having constant length,
c) a PDU having a dynamic length,
d) a plurality of PDUs 21 having a dynamic length, and
e) both PDUs 22 having a constant length and PDUs 21 having a dynamic length.

The above list a) to e) initially reflects only the configuration of a message 20. It is possible that at runtime, not all configured PDUs 21, 22 are always transmitted in one message 20. For example, a transport layer PDU may possibly exist in message 20 only as part of a diagnosis session.

In the following exemplary embodiments, to reduce the required bandwidth EOP marker 23 is inserted only after PDUs 21 that may have a dynamic length. Since in PDUs 22 having a constant length, the length is configured in the preliminary stages already and is not modified at runtime, EOP marker 23 is not required for constant data blocks 22. However, it is of course possible to insert an EOP marker 23 into message 20 after constant data blocks 22 as well, for example, in order to standardize the algorithms for inserting EOP marker 23 in the transmitting user and for ascertaining the end of data blocks 21, 22 in the receiving user.

For the detection of dynamic PDUs 21, the possible combinations of PDUs 21, 22 in a message 20 listed above under a) to e) must be considered.

In case a) it is not necessary to insert and detect an EOP marker 23, since in PDUs 22 having a constant length, the length is already known in advance from the configuration and is not changed again during the runtime. The same is true for a plurality of constant PDUs 22 per message 20 in case b).

When one PDU 21 having a dynamic length is used per message 20 in accordance with case c), the detection of dynamic PDU 21 through EOP marker 23 is very simple, since it is already known at the time of configuration that only one PDU 21 having a dynamic length is located in frame 20. Accordingly, the remaining PDUs 22 in frame 20 have a constant length. In this case, it would even be possible to omit EOP marker 23, since it is not necessarily required to ascertain the length of dynamic PDU 21, but it may simplify the determination of the length of PDU 21. However, it is retained for consistency reasons and to simplify a software solution. Apart from this, the following cases are to be considered:
If dynamic PDU 21 is situated at the end of frame 20, then the determination of the start is very simple, since the length of the preceding static PDUs 22 is known from the configuration.
If dynamic PDU 21 is situated at the start of frame 20, it is possible to calculate its length with the aid of the lengths of the statically configured PDUs 22.
If dynamic PDU 21 is situated between static PDUs 22, the position and length may be calculated using the lengths of the “surrounding” PDUs 22.

When a plurality of PDUs 21 having a dynamic length are used per message 20 in accordance with case d), an EOP marker 23 is definitely necessary in order to be able to detect the end of dynamic PDUs 21. Even though it is slight, there is a risk that EOP marker 23 will also appear in the transmitted data as part of payload 13 of a PDU 21, 22. FIG. 3 illustrates an example in which one EOP marker 23 is inserted at the end of PDUs 21, 22, respectively. A bit combination is contained in PDU #2 having a constant length, which bit combination corresponds to the bit combination selected for EOP marker 23. Thus, theoretically there is a risk that bit combination 24 will be falsely identified as the EOP marker in the receiver after the bit stream is received and evaluated. This can be prevented using the algorithm described below.

EOP markers 23 are evaluated starting from the end of frame 20. It becomes clear that the first marker 23 that occurs must mark the end of last PDU#3; the next marker 23 must consequently mark the end of the next-to-last PDU#2. In the two bit combinations 24, 23 following in the sequence of the evaluation, however, it is not possible to detect immediately where the next-to-last PDU#2 begins and where PDU#1, which precedes it, ends. In this instance, it is possible to detect reliably the end of PDU 22 only by introducing an additional configuration parameter, to with the configuration of the minimum or maximum length of a PDU 21, 22. The next valid marker 23 may be detected via a plausibilization of the two lengths and of the position of bit combinations 24, 23, and thus the length and position of second PDU#2 and of first PDU#1 may be determined. The detection of EOP marker 23 may also be started from the beginning of frame 20 or from any other position.

The last case e) mentioned above is a special case. For the sake of simplicity, the following cases are described for only three PDUs 21, 22, by way of example. If more PDUs are found in frame 20, the correct algorithm for detecting EOP marker 23 may be derived through the combination of the cases described below and the preceding explanations.

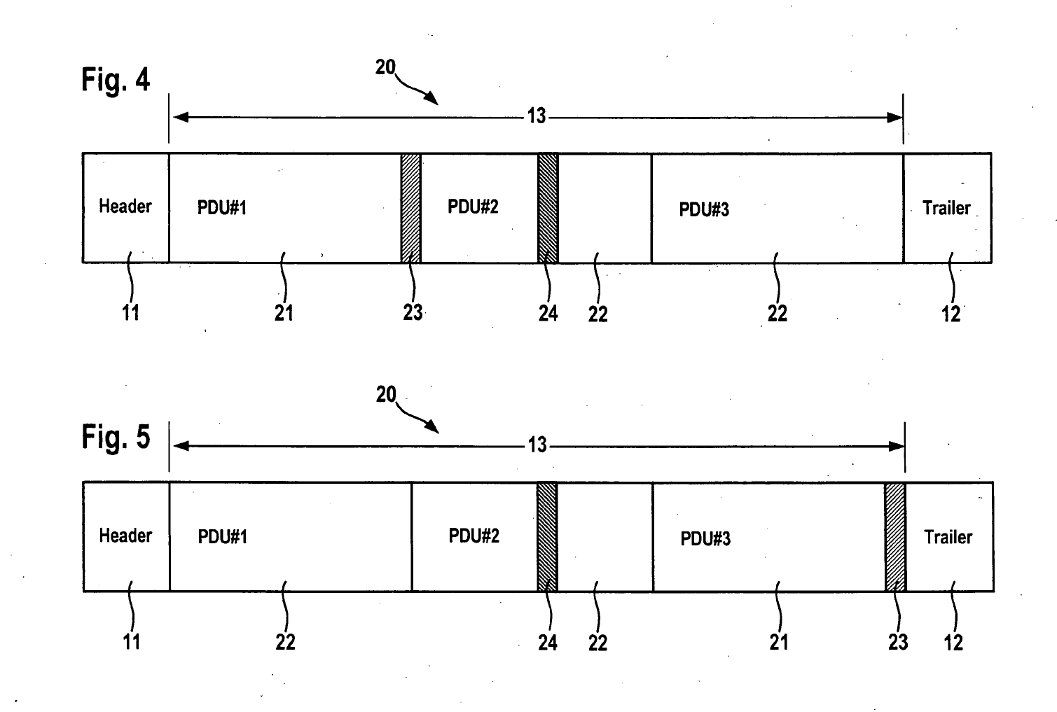

FIG. 4 illustrates a subcase of case e), in which a PDU 21 having a dynamic length is located at the start of frame 20 and is followed only by PDUs 22 having a constant length. This subcase may be treated like the above case c), which is described in more detail (“one PDU of dynamic length per frame”).

According to an additional subcase of case e), which is illustrated in FIG. 5, PDU 21 having dynamic length is located at the end of frame 20, and only PDUs 22 having a constant length are disposed in front of it. In this subcase, the detection of the end of dynamic PDU 21 is also simplified by the fact that only the last PDU #3 has a dynamic length. If a bit combination 24 that corresponds to the bit combination selected for EOP marker 23 is coincidentally located within payload 13 of the other (constant) PDUs 22, this bit combination 24 may be ignored.

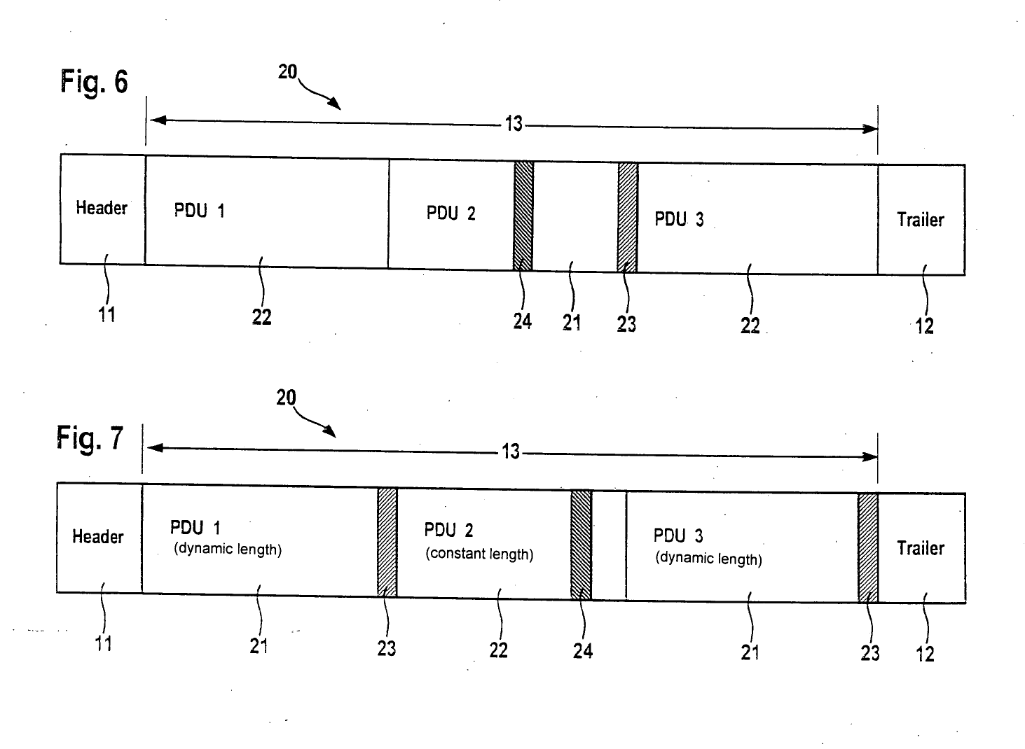

An additional subcase of case e) is illustrated in FIG. 6, in which a PDU 21 having a dynamic length is located between two PDUs 22 having a constant length. In this instance, the position of dynamic PDU 21 may be detected very easily with the aid of the two constant PDUs. Last PDU#3 has a constant length; for this reason the first occurring bit combination (viewed from the end of message 20) must be the correct EOP marker 23. All other bit patterns occurring in the bit stream, which correspond to the bit combination of EOP marker 23, may be ignored.

In accordance with yet another subcase of case e), which is shown in FIG. 7, a PDU 22 having a constant length is located between two PDUs 21 having a dynamic length. In principle, the detection of two dynamic PDUs 21 is made possible by the following simplification:
the minimum and the maximum length of dynamic PDUs 21 are known and may not be identical,
if a PDU 22 having a constant length exists and is located between PDUs 21 having a dynamic length, its length must be greater than or equal to the dynamic length of PDUs 21, since false EOP markers (e.g., bit combination 24) within it may be ignored.

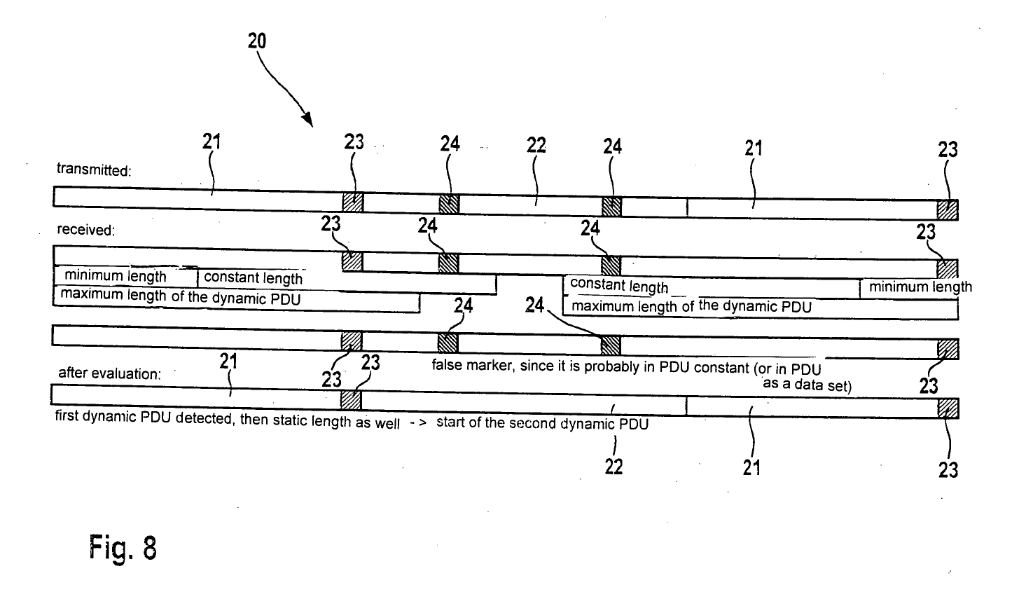

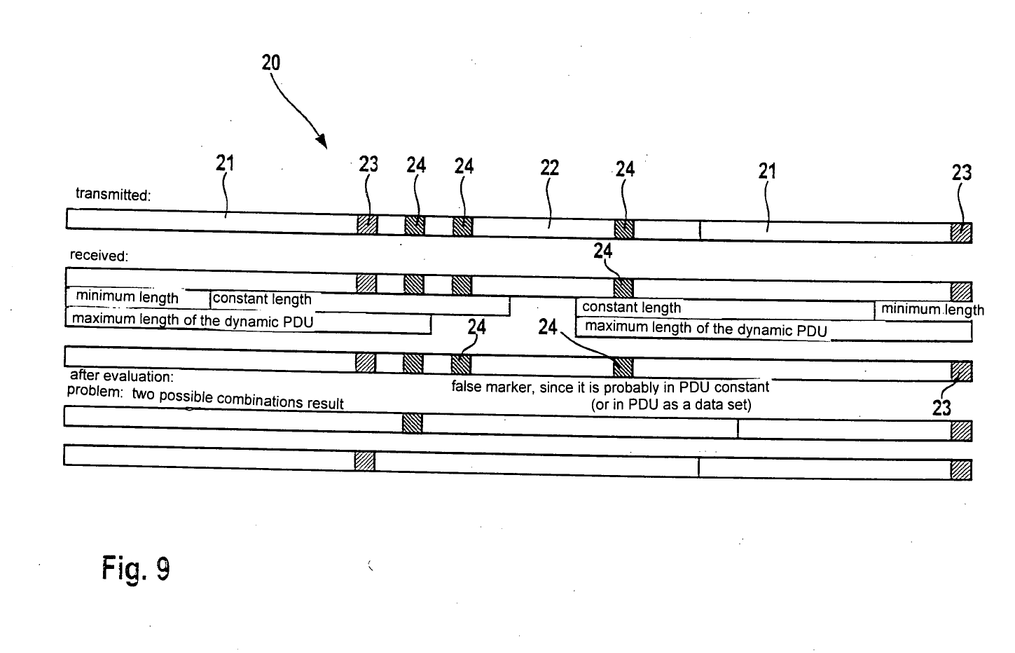

FIG. 8 illustrates one exemplary embodiment of the present invention, in which two invalid bit patterns 24, which correspond to the bit combination of EOP marker 23, exist in a message 20. It is possible to determine unequivocally the valid EOP markers 23 and thus the position and length of PDUs 21, 22 contained in frame 20.

FIG. 9 illustrates another exemplary embodiment of the present invention, in which a plurality of invalid bit patterns 24, three in the example, which correspond to the bit combination of EOP marker 23, exist in a message 20. Even when the above-defined prerequisites are fulfilled, it is not possible to clearly identify valid EOP markers 23. A clear determination of the position and length of PDUs 21, 22 is thus not possible in this exceptional case.

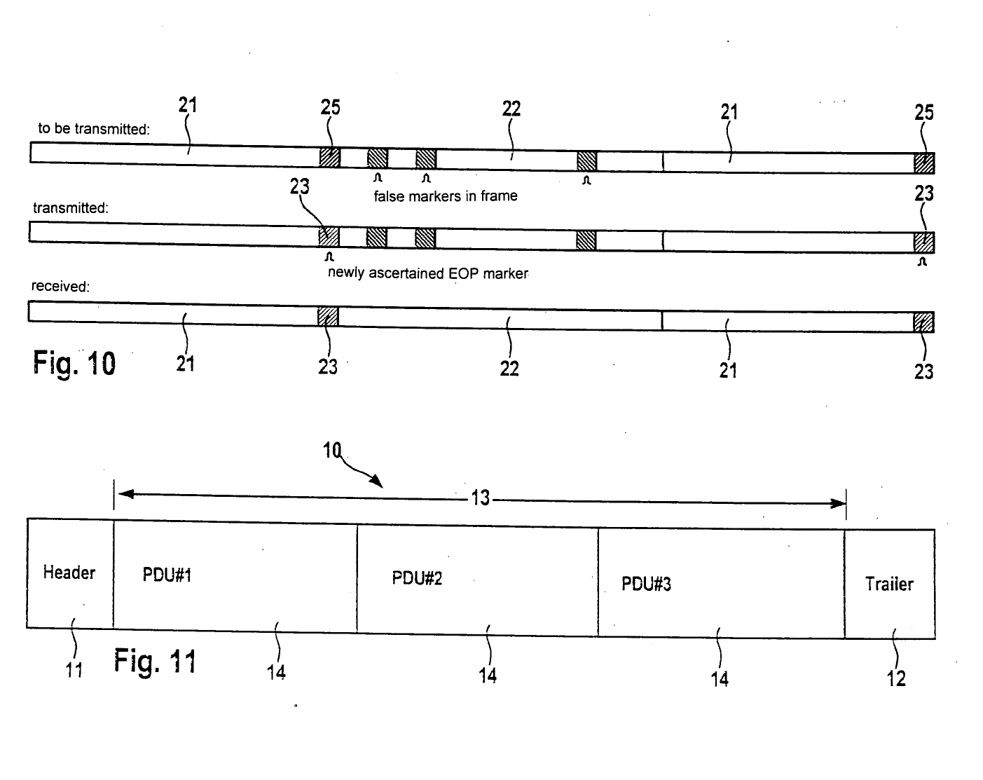

The above-listed examples make clear that a previously defined EOP marker 23 helps to clearly detect PDUs 21, 22 of a message. The problems described in clearly identifying EOP marker 23 in a message may be prevented if instead of an EOP marker 23 having a static content defined in advance, a dynamic EOP marker 23 generated at runtime is used. This is explained in more detail below with the aid of FIG. 10. In this context, the bit combination of EOP marker 23 is ascertained dynamically with the aid of payload 13. To this end, payload 13 of frame 20 is compiled from individual PDUs 21, 22 before the data is transmitted, place holders 25 being held for the EOP markers. Subsequently, entire frame 20 is analyzed, in order to find a byte having a unique bit sequence that does not occur within payload 13. This sequence forms new EOP marker 23 for this frame 20 and is used before the actual data transmission in the position of place holder 25. In the receiver, the “false markers in the frame” are not detected as such, since these are very normal bit sequences of the transmitted data that have nothing to do with the bit sequence of EOP markers 23.

Of course, marker 23 may also include more than one byte. On the receiver side, the bit sequence used as EOP marker 23 for current frame 20 is detected, since the receiver knows that the bit sequence must be at the end of the last PDU. This being the case, it is not necessary for additional information regarding the bit sequence in use to be transmitted from the transmitter to the receiver.

1-16. (canceled)

17. A method for transmitting data, comprising:
transmitting data through a communication medium from a transmitting user of a communication system to a receiving user of the communication system, wherein the data are transmitted in messages which each respectively include a plurality of data blocks having variable length;
identifying by the receiving user the end of the data blocks in the received messages, wherein the end of the data blocks in the received messages is identified by one of: a) evaluating length information contained in the data blocks regarding the length of the data blocks, wherein the length information is transmitted in the data blocks; or b) evaluating end information regarding the end of the data blocks transmitted in the messages, wherein the end information is transmitted after the data blocks having variable length; and
subsequently extracting by the receiving user the transmitted data from the identified data blocks.

18. The method as recited in claim 17, wherein the method is used in a cycle-based communication system, and wherein the data are transmitted in messages which repeat in communication cycles.

19. The method as recited in claim 18, wherein the content of the bytes of the data transmitted in the messages is ascertained in the transmitting user, and wherein a bit combination not present in the content of the bytes of the data transmitted in the messages is selected as the end information regarding the end of the data blocks.

20. The method as recited in claim 19, wherein the data are transmitted in accordance with FlexRay protocol.

21. The method as recited in claim 19, wherein the end information regarding the end of the data blocks includes at most two bytes.

22. The method as recited in claim 19, wherein the end information regarding the end of the data blocks includes exactly one byte.

23. The method as recited in claim 19, wherein information regarding the minimum length of the data blocks and the maximum length of the data blocks is available to the receiving user, and wherein the receiving user identifies the end information regarding the end of the data blocks by searching for the end information in only the region delimited by the minimum and the maximum length of the data blocks.

24. A communication system, comprising:
at least a first user component and a second user component; and
at least one communication medium connecting the first user component and the second user component to each other for data transmission;
wherein the first and second user components each include:
means for transmitting data in messages which each respectively include a plurality of data blocks having variable length;
means for identifying the end of the data blocks in the received messages, wherein the end of the data blocks in the received messages is identified by one of: a) evaluating length information contained in the data blocks regarding the length of the data blocks, wherein the length information is transmitted in the data blocks; or b) evaluating end information regarding the end of the data blocks transmitted in the messages, wherein the end information is transmitted after the data blocks having variable length; and
means for subsequently extracting by the receiving user the transmitted data from the identified data blocks.

25. The communication system as recited in claim 24,
wherein the communication system is a cycle-based communication system, and wherein the first and second users transmit the data via the communication medium in messages which repeat in communication cycles.

26. The communication system as recited in claim 25, information regarding the minimum length of the data blocks and the maximum length of the data blocks is available to the user receiving the messages, and wherein the user receiving the messages identifies the end information regarding the end of the data blocks by searching for the end information in only the region delimited by the minimum and the maximum length of the data blocks.

27. A communication system, comprising:
at least a first user component and a second user component; and
at least one communication medium connecting the first user component and the second user component to each other for data transmission;
wherein at least one of the first and second user components includes:
means for transmitting data in repeating messages which each respectively include a plurality of data blocks having variable length, wherein the means for transmitting data includes (i) first means for inserting the data to be transmitted into the plurality of data blocks data, and (ii) second means for inserting one of (a) length information into the data blocks regarding the length of the data blocks, or b) end information regarding the end of the data blocks transmitted in the messages, wherein the end information is inserted after the data blocks having variable length.

28. The communication system as recited in claim 27,
wherein the communication system is a cycle-based communication system, and wherein the first and second users transmit the data via the communication medium in messages which repeat in communication cycles.

29. The communication system as recited in claim 28, wherein the second means ascertain the content of the bytes of the data to be transmitted in the messages, and wherein the second means select a bit combination not present in the content of the bytes of the data transmitted in the messages as the end information regarding the end of the data blocks.

30. The communication system as recited in claim 29, wherein the data are transmitted in the communication system in accordance with FlexRay protocol.

31. The communication system as recited in claim 29, wherein the end information regarding the end of the data blocks includes at most two bytes.

32. The communication system as recited in claim 29, wherein the end information regarding the end of the data blocks includes exactly one byte.
